(19) United States
(12) Patent Application Publication
(10) Pub. No.: US 2026/0184298 A1
(43) Pub. Date: Jul. 2, 2026

(54) SYSTEMS AND METHODS FOR IMPLEMENTING A VEHICLE DRIVE MODE

(71) Applicant: Cummins Inc., Columbus, IN (US)

(72) Inventors: Shiyu Hu, Wuhan (CN); Yang Z. Zhou, Wuhan (CN); Lingyun Chen, Wuhan (CN); Yuan Zoe, Wuhan (CN); Meng Xu, Wuhan (CN); Chengxiu Huang, Wuhan (CN)

(73) Assignee: Cummins Inc., Columbus, IN (US)

(21) Appl. No.: 19/434,510

(22) Filed: Dec. 29, 2025

(30) Foreign Application Priority Data
Dec. 30, 2024 (CN) 202411976650.X

(51) Int. Cl. B60W 20/13; B60K 6/40; B60W 10/06; B60W 10/08; B60W 20/15

(52) U.S. Cl. CPC B60W 20/13; B60K 6/40; B60W 10/06; B60W 10/08; B60W 20/15; B60W 2510/1015; B60W 2510/244; B60W 2710/0677; B60W 2710/086; B60Y 2200/92

(57) ABSTRACT

An engine system for a vehicle includes a controller coupled to an engine, an electric machine, a battery, a series of user input devices, and a transmission. The controller is configured to perform operations. The operations include receiving information regarding the state of operation of the vehicle, further including information regarding vehicle speed, transmission speed, and drive demand power. The controller is further configured to calculate a fuel saved ratio representing efficiency of the engine system and determine how to maximize the efficiency of the system. The operations of the controller further include operating the components of the engine system in order to maximize system efficiency and fuel savings.

### CROSS-REFERENCE TO RELATED PATENT APPLICATIONS

This patent application claims the benefit of and priority to C.N. patent application No. 202411976650.X filed on Dec. 30, 2024, which is incorporated herein by reference in its entirety and for all purposes.

### FIELD

The present disclosure relates generally to systems and methods for implementing a vehicle drive mode. In particular, the present disclosure relates to systems and methods for implementing a vehicle drive mode in hybrid vehicle systems.

### BACKGROUND

A hybrid vehicle system can include an internal combustion engine and an electric machine that cooperate to propel the vehicle. The amount of power output by the engine and/or the amount of power output or generated by the electric machine is often rule-based and may rely on experience and/or simulation. Many rule-based energy management systems estimate the thresholds used to determine an amount of power output by engine and/or the amount of power output or generated by the electric machine.

### SUMMARY

One embodiment relates to a system. The system includes a controller coupled to an engine, an electric machine, a battery, and a transmission. The controller includes at least one processor and at least one memory device storing instructions, that when executed by the at least one processor, cause the controller to perform operations. The operations include: receiving a state of charge value regarding a battery; determining, based on the state of charge value, a fuel saved ratio value; receiving a target fuel saved ratio value; receiving a transmission speed value regarding the transmission; receiving a drive demand power value; determining, based on the target fuel saved ratio value and the transmission speed value, one or more power thresholds; determining a vehicle drive mode based on comparing the drive demand power value to the one or more power thresholds; and implementing the vehicle drive mode by causing the powertrain to operate according to the vehicle drive mode.

Another embodiment relates to a method. The method includes: receiving, by a controller, a state of charge value regarding a battery coupled to the controller; determining, by the controller and based on the state of charge value, a fuel saved ratio value regarding an amount of fuel saved when discharging one unit of energy from the battery or an amount of fuel consumed when one unit of energy is charged to the battery; receiving, by the controller, a target fuel saved ratio value; receiving, by the controller, a transmission speed value regarding operation of a transmission coupled to the controller; receiving, by the controller, a drive demand power value indicative of an amount of power demanded from a vehicle including the transmission; determining, by the controller, one or more power thresholds based on the target fuel saved ratio value and the transmission speed value; determining, by the controller, a vehicle drive mode based on comparing the drive demand power value to the one or more power thresholds; and implementing, by the controller, the vehicle drive mode by causing a powertrain of the vehicle coupled to the controller to operate according to the vehicle drive mode.

Still another embodiment relates to a non-transitory computer-readable media storing instructions that, when executed by one or more processors of at least one processing circuit, cause the at least one processing circuit to perform operations. The operations include: receiving, by a controller, a state of charge value regarding a battery coupled to the controller; determining a fuel saved ratio value regarding an amount of fuel saved when discharging one unit of energy from the battery or an amount of fuel consumed when one unit of energy is charged to the battery, based on the state of charge value; receiving a target fuel saved ratio value; receiving a transmission speed value regarding operation of a transmission coupled to the controller; receiving a drive demand power value indicative of an amount of power demanded from a vehicle including a transmission; determining one or more power thresholds based on the target fuel saved ratio value and the transmission speed value; determining vehicle drive mode based on comparing the drive demand power value to the one or more power thresholds; and implementing the vehicle drive mode by causing a powertrain of the vehicle coupled to the controller to operate according to the vehicle drive mode.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of an engine system, according to an example embodiment.

FIG. 2 is a block diagram of a controller of the engine system of FIG. 1, according to an example embodiment.

FIG. 3 is a flow diagram of a method of calculating a state of charge and fuel saved ratio for the system of FIG. 1, according to an example embodiment.

FIG. 4 is a flow diagram of a method of determining a vehicle drive mode for the system of FIG. 1, according to an example embodiment.

FIG. 5 is a graph of drive demand power and transmission speed used to determine a vehicle drive mode for the system of FIG. 1, according to an example embodiment.

FIG. 6 is a pair of graphs depicting drive demand power and speed that may be used to determine a vehicle drive mode for the system of FIG. 1, according to an example embodiment.

### DETAILED DESCRIPTION

Following below are more detailed descriptions of various concepts related to, and implementations of, methods, apparatuses, computer-readable media, and systems for optimizing efficiency in a hybrid vehicle system. Before turning to the Figures, which illustrate certain exemplary embodiments in detail, it should be understood that the present disclosure is not limited to the details or methodology set forth in the description or illustrated in the Figures. It should also be understood that the terminology used herein is for the purpose of description only and should not be regarded as limiting.

As described herein, an engine system may include an engine and an electric machine coupled to a transmission and configured to propel a vehicle. The engine may be an internal combustion engine configured to combust fuel and generate mechanical power. The electric machine may receive electrical power and generate mechanical power.

Advantageously and as described herein, a control system or controller may implement one or more controls to operate the engine and/or electric machine in one or more different modes to minimize fuel consumption of the engine system. In an example embodiment, the controller may implement a set of controls to operate the engine and electric machine in a power split mode, causing both the engine and the electric machine to provide mechanical power to propel the vehicle. In another example embodiment, the controller may implement a set of controls to operate the engine system in an engine only mode, causing the engine to provide mechanical power to propel the vehicle. In still another example embodiment, the controller may implement a set of controls to operate the engine system in an engine and recharge mode, causing the engine to provide mechanical power to propel the vehicle and to cause the electric machine to generate electrical power, which may be used to power an electrical device and/or to charge a battery. In yet another example embodiment, the controller may implement a set of controls to operate the engine system in an electric vehicle mode, causing the electric machine to provide mechanical power to propel the vehicle. In still yet another example embodiment, the controller may implement a set of controls to operate the engine system in a regeneration mode, causing the electric machine to generate power (e.g., via regenerative braking).

Rule-based energy management systems rely on experience and/or simulation. This may lead to estimation of thresholds used to operate an engine system (e.g., the engine and/or the electric machine in a hybrid system). In operation, this can result in increased fuel consumption. Over time, an estimated threshold may prove to be errant, and fail to produce commands specific to a present need (e.g., proper vehicle drive mode for minimum fuel consumption). For example, the vehicle drive mode is determined by an operator input (via an operator input device) and/or is automatically commanded by the controller at various operating instances, such as periods of high power demand (e.g., accelerating up an incline, etc.). A rule-based decision may be made from operation of the system that results in a fuel-intensive vehicle drive mode (e.g., engine only mode, resulting in only the engine providing the drive power). In this way, fuel consumption is not minimized as a result of rule-based control.

Technically and beneficially, the systems, computer-readable media, and methods described herein relate to automatically implementing a vehicle drive mode for an engine system. In particular, the systems, computer-readable media, and methods described herein and, among other benefits, provide a technical solution to the technical problem of reducing fuel consumption in an engine system and particularly a hybrid engine system that results in an improvement of operation relative to the above-described rule-based control systems. In particular, the technical solution includes receiving, by a controller, drive demand power. The drive demand power is a value representing power demanded from a vehicle, including, for example, the transmission, by the operator, where the value is negative while the brake is being operated, positive while the accelerator is being operated (particularly depressed), and zero when neither the brake nor the accelerator pedal is operated. While the vehicle is being operated, the controller receives a transmission speed value and a fuel saved ratio associated with a current state of the engine system. The controller may automatically change the vehicle drive mode responsive to the drive demand power value being at or above a predetermined threshold such that the specific vehicle drive mode is implemented responsive to receiving the request for the vehicle drive mode. Advantageously, the mode determination process may reduce fuel consumption of the engine system. That is, without this selection process and automatic operation, fuel consumption may be greater. These and other features and benefits are described more fully herein below.

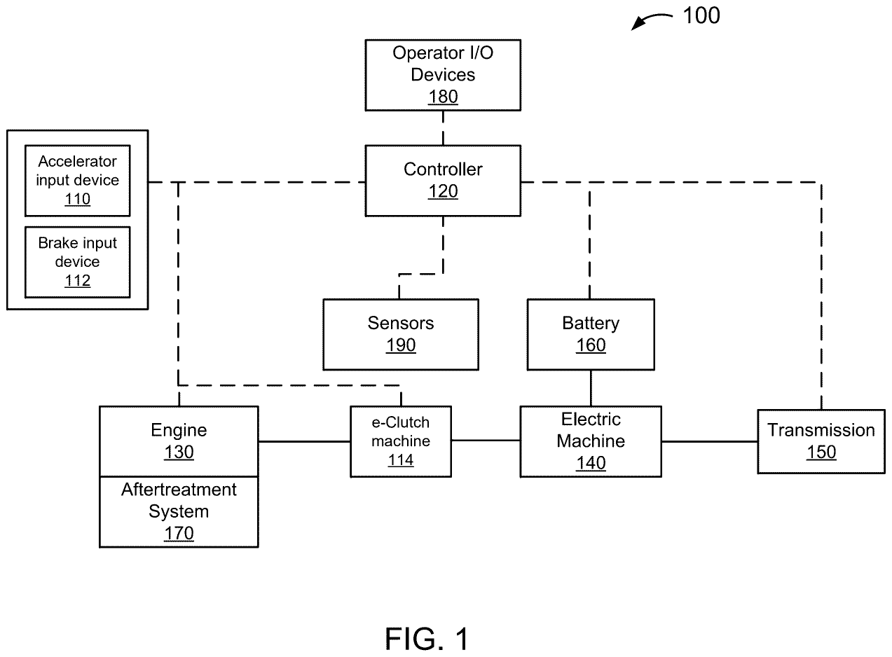

Referring to FIG. 1, a schematic view of a diagram of an engine system 100 is shown, according to an example embodiment. The engine system 100 includes an engine 130, an exhaust aftertreatment system 170 in exhaust gas receiving communication with the engine 130, at least one electric machine 140, a battery 160 coupled to the at least one electric machine 140, and a transmission 150 coupled to the engine 130, the electric machine 140, or both. The engine system 100 includes one or more input devices (e.g., a clutch, brake, and accelerator) shown as accelerator input device 110, brake input device 112, and an electronic clutch or e-clutch machine 114. The e-clutch machine 114 or input device may be actuated/controlled by at least one of an operator or the controller 120 (or, in some embodiments, based on signals from an embedded controller that may receive commands from the controller 120). The engine system 100 includes a controller 120 and an operator input/output (I/O) device 180, where the controller 120 is communicably coupled to each of the aforementioned components. In the configuration of FIG. 1, the engine system 100 is included in a vehicle. The vehicle may be any type of on-road or off-road vehicle including, but not limited to, wheel-loaders, fork-lift trucks, line-haul trucks mid-range trucks (e.g., pick-up truck, etc.), sedans, coupes, tanks, airplanes, boats, and any other type of vehicle. In another embodiment, the system 100 may be embodied in a stationary piece of equipment, such as a power generator or genset. All such variations are intended to fall within the scope of the present disclosure.

In the configuration shown in FIG. 1, the engine system 100 is a hybrid engine system having a combination of the engine 130 and at least one of the electric machine 140 coupled to the battery 160. For example as shown in FIG. 1, the engine system includes the electric machine 140 (e.g., a motor, a motor generator, etc.) that is coupled to the engine 130 via a shaft (e.g., an output shaft, a drive shaft, a crankshaft, etc.). The battery 160 is an energy storage device that is configured to store electrical energy. The battery 160 may be or include one or more battery cells and/or one or more capacitors. The battery 160 may selectively provide and/or receive electrical energy to/from the electric machine 140. In some embodiments, the system 100 includes more than one battery 160 (e.g., two or more batteries). In some embodiments, the engine system 100 may be configured as a mild-hybrid powertrain, a parallel hybrid powertrain, a series hybrid powertrain, or a series-parallel powertrain.

The engine 130 may be an internal combustion engine that is configured to receive a signal from the controller 120 and produce mechanical power. The engine 130 is an internal combustion engine (ICE). The ICE may be a compression ignition engine or a spark-ignited engine. As such, the ICE may consume one or more of a variety of fuels, such as diesel, gasoline, hydrogen, natural gas, propane, etc., to generate power.

The engine 130 may include one or more cylinders (e.g., combustion cylinders) disposed within a combustion chamber of the engine 130. The cylinders enable combustion of fuel within the engine 130. The combustion of fuel causes the engine 130 to rotate, thereby generating mechanical power to rotate the transmission 150. Rotation of the transmission 150 may cause rotation of one or more wheels, thereby propelling the vehicle.

In some embodiments, the aftertreatment system 170 is in exhaust gas receiving communication with the engine 130. The aftertreatment system 170 includes components used to reduce exhaust emissions. Such as a selective catalytic reduction (SCR) catalyst, and oxidation catalyst (OC), a particulate filter (PD), an exhaust fluid doser with a supply of exhaust fluid, a plurality of sensors for monitoring the aftertreatment system (e.g., a nitrogen oxide (NOx) sensor, temperature sensors, etc.), and/or still other components.

The electric machine 140 may be an electric motor, a motor generator, and/or another type of electric machine that is configured to receive and use electrical power (e.g., from the at least one battery 160) to output mechanical power. The electric machine 140 is coupled to the battery 160 such that the electric machine 140 is operable to provide power to and/or receive power from the battery 160. In some embodiments, the electric machine 140 is communicably coupled to the controller 120, such that, responsive to receiving an indication that the vehicle drive mode is one of the electric vehicle drive mode or the power split drive mode, the electric machine 140 receives electrical energy from at least one battery 160, produces mechanical power, and provides the produced mechanical power to the transmission 150. In some embodiments, the electric machine 140 is configured to supply power to brake the vehicle in response to receiving an indication from the controller 120 that the vehicle is in the regenerative drive mode. In some embodiments, the electric machine 140 is configured to supply power to charge the battery 160 in response to receiving an indication from the controller 120 that the vehicle drive mode is engine and recharge mode.

Together, the engine 130 and the electric machine 140 define a powertrain. In some embodiments, the powertrain also includes the transmission 150. In some embodiments, the powertrain also includes the battery 160. In some embodiments, the powertrain also includes a driveshaft, one or more axles, a differential, and/or other components used to propel the vehicle.

The accelerator input device 110, the brake input device 112, and the e-clutch machine 114 are configured to selectively receive inputs from a user (and/or from other components/systems of the system 100). The accelerator input device 110 may be a pedal, a lever, a button, one or more switches, and/or another type of user interface device (e.g., voice transceiver) configured to receive a user input to demand acceleration of the vehicle. In some embodiments, the accelerator input device 110 is coupled to the controller 120 such that the accelerator input device 110 sends input signals to the controller 120 to demand acceleration of the vehicle. For example, the accelerator input device 110 may be an accelerator pedal that, when depressed by an operator, causes the controller 120 to increase the speed of the vehicle. In some other embodiments, the accelerator input device 110 may be a hand-operated lever configured to be operable between a plurality of positions to increase and decrease the acceleration of the vehicle. For example, the accelerator input device 110 may be a hand-operated lever configured to be pushed and/or pulled by an operator to send signals to the controller 120 to increase or decrease the speed of the vehicle based on the position of the accelerator input device 110.

The brake input device 112 may be a pedal, a lever, a button, one or more switches, and/or any other type of user interface device (e.g., voice transceiver) configured to receive a user input to brake the vehicle. In some embodiments, the brake input device 112 is coupled to the controller such that the brake input device 112 sends input signals to the controller 120 to demand braking of the vehicle. For example, the brake input device 112 may be a brake pedal that, when depressed by an operator, causes the controller 120 to brake the vehicle. In some other embodiments, the brake input device 112 may be a hand brake configured to allow an operator to apply braking force by squeezing a lever. In some other embodiments, the brake input device 112 may be a lever configured to be pushed and/or pulled between a deployed position and a stowed position, wherein operating the brake input device 112 from the stowed position to the deployed position causes the controller 120 to brake the vehicle.

The e-clutch machine 114 may include or be coupled to a pedal, a lever, a button, a plurality of switches, and/or another type of user interface device configured to receive user inputs to enable changing of gears/settings of the transmission 150 to cause various driveshaft and, ultimately, vehicle speeds. In other embodiments, these user interface devices may be excluded and the e-clutch machine 114 may automatically operate based on one or more commands (e.g., from the controller 120). In some embodiments, the e-clutch machine 114 is coupled to the controller such that, upon being operated, the controller 120 causes the e-clutch machine 114 to engage and/or disengage the engine 130 with the electric machine 140. For example, the e-clutch machine 114 may include a clutch pedal that, when depressed by an operator, causes the controller 120 to allow the engagement and/or disengagement between the engine 130 and the electric machine 140. In some embodiments, the e-clutch machine 114 may include a hand-operated lever configured to allow engagement and/or disengagement between the engine 130 and the electric machine 140 in response to being operated. In some other embodiments, the e-clutch machine 114 may include at least one paddle shifter configured to enable the engagement and/or disengagement between the engine 130 and the electric machine 140 when operated by a user.

The accelerator input device 110, the brake input device 112, and the e-clutch machine 114 are communicably coupled to the controller 120 such that, upon being operated (e.g., pushed, released, etc.), the accelerator input device 110, the brake input device 112, and the e-clutch machine 114 generate and send at least one signal to the controller 120. In some embodiments, this signal may be characterized as drive demand power, including an indication of power demanded by an operator regarding at least one of transmission speed, vehicle speed, connection between the engine 130 and the electric machine 140, and/or connection between the powertrain and transmission 150.

The operator input/output device 180 may be coupled to the controller 120, such that information may be exchanged between the controller 120 and the I/O device, where the information may relate to one or more components of FIG. 1 or determinations of the controller 120. The operator I/O device 180 enables an operator of the engine system 100 to communicate with the controller 120 and one or more components of the engine system 100 of FIG. 1. For example, the operator input/output device 180 may include, but is not limited to, an interactive display, a touchscreen device, one or more buttons and switches, voice command receivers, etc. In this way, the operator input/output device may provide one or more indications or notifications to an operator, such as a malfunction indicator lamp, etc. Additionally, the vehicle may include a port that enables the controller 120 to connect or couple to a scan tool so that fault codes and other information regarding the vehicle may be obtained.

Depending on the hybrid vehicle configuration (e.g., series, parallel, series-parallel etc.), the transmission 150 is coupled to the electric machine 140 and/or engine 130. In any hybrid vehicle configuration, the electric machine 140 is coupled to the transmission 150, such that the electric machine rotates the transmission 150 and/or one or more components thereof. In some configurations (e.g., parallel, or series-parallel) the engine 130 is directly coupled to the transmission 150. In other configurations (e.g., series or series-parallel) the engine 130 is indirectly coupled to the transmission 150 (e.g., via the electric machine 140). In any hybrid vehicle configuration, the transmission 150 is coupled to the engine 130 (e.g., directly, or indirectly), such that the engine rotates the transmission 150 and/or one or more components thereof. In some embodiments, the transmission 150 is a multi-speed transmission having a set of gears that are selectively engageable with each other to achieve one of a predefine set of gear ratios. In other embodiments, the transmission 150 is a single speed transmission having a set of gears that are engaged with each other to achieve a single, predefined gear ratio.

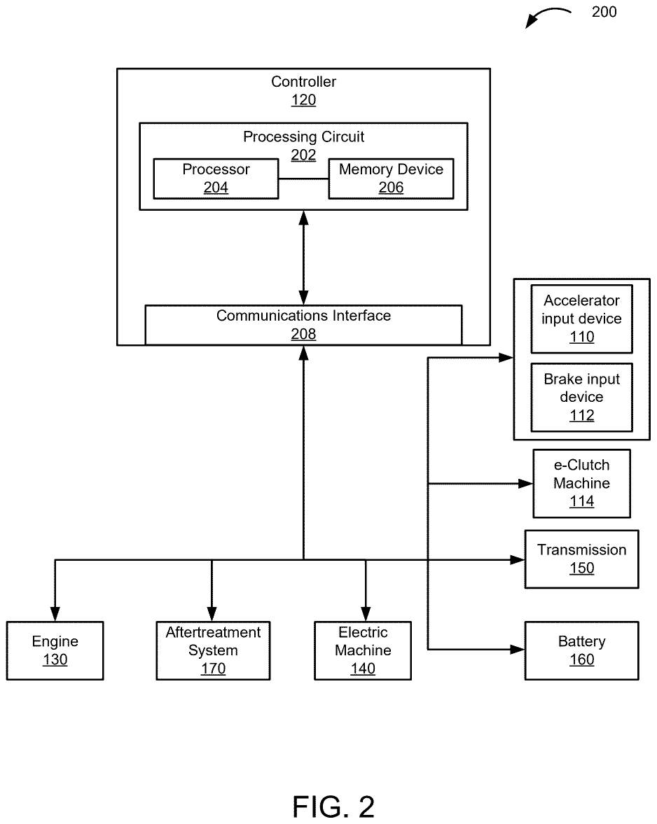

Referring now to FIG. 2, a schematic diagram of the controller 120 of the engine system 100 of FIG. 1 is shown, according to an example embodiment. As shown, the controller 120 includes at least one processing circuit 202 having at least one processor 204 and at least one memory device 206, and a communications interface 208. The controller 120 is configured to control operation of other components of the engine system 100. In some embodiments, the controller 120 may control operation of the engine 130, the electric machine 140, and/or other components of the engine system 100 to achieve a desired or target parameter value (e.g., vehicle speed, transmission speed, battery state of charge, fuels saved ratio, vehicle drive mode, etc.).

The controller 120 includes at least one processing circuit 202 having the at least one processor 204 and the at least one memory device 206. The processing circuit 202 may be structured or configured to execute or implement the instructions, commands, and/or control processes described herein.

The at least one processor 204 may be implemented as one or more single- or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. Alternatively or additionally, the one or more processors 204 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The at least one memory device 206 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 206 may include dynamic random-access memory (DRAM). The memory device 206 may be communicably coupled to the processor 204 to provide computer code or instructions to the processor 204 for executing at least some of the processes described herein. Moreover, the memory device 206 may be or include tangible, non-transient volatile memory, or non-volatile memory. Accordingly, the memory device 206 may include database components, object code components, script components, or any other type of information structure for supporting the various activities and information structures described herein.

The communications interface 208 may include any combination of wired and/or wireless interfaces (e.g., jacks, antennas, transmitters, receivers, transceivers, wire terminals, etc.) for conducting data communications with various systems, devices, or networks structured to enable in-vehicle communications (e.g., between and among the components of the engine system 100 of the vehicle) and out-of-vehicle communications (e.g., with a remote server). For example, and regarding out-of-vehicle/system communications, the communications interface 208 may include an Ethernet card and port for sending and receiving data via an Ethernet-based communications network and/or a Wi-Fi transceiver for communicating via a wireless communications network. The communications interface 208 may be structured to communicate via local area networks or wide area networks (e.g., the Internet) and may use a variety of communications protocols (e.g., IP, LON, Bluetooth, ZigBee, radio, cellular, near field communication).

As further shown in FIG. 2, the communications interface 208 may enable communication with the engine 130, the aftertreatment system 170, the electric machine 140, the transmission 150, the battery 160, and/or the accelerator input device 110, the brake input device 112, and the e-clutch machine 114.

In an example embodiment, the controller 120 is configured to retrievably store an optimized fuel saved ratio discharge model (e.g., map) and an optimized fuel saved ratio charge model (e.g., map). As described herein a “map” refers to a set of data values that are related to each other. For example, each map relates at least one of a first parameter value (e.g., a first input value) or a second parameter value (e.g., a second input value) (or more input values) to a third parameter value (e.g., an output value). In various example embodiments, the maps may relate a transmission speed value (e.g., the first input value) and a drive demand power value (e.g., the second input value) to a fuel saved ratio value (e.g., the output value).

The “fuel saved ratio” value is an amount of fuel saved when discharging one unit (e.g., one kilowatt-hour) of energy from the battery 160 or the amount of fuel consumed when charging one unit (e.g., one kilowatt-hour) of energy to the battery 160. The fuel saved ratio value can be calculated as a function of one or more of a fuel consumption rate when only the engine supplies the drive demand power (FR_{EngOnly}) a fuel consumption rate when the engine and battery combine to supply the drive demand power (FR_{Eng,Batt}), and a power output by the battery 160 (P_{Batt}) This relationship is described by equation 1 below.

$$FSR = \frac{{FR}_{EngOnly} - {FR}_{Eng , Batt}}{{P}_{B a t t}} \qquad ( 1 )$$

For each map, one or more fuel saved ratio patterns (e.g., curves) may be obtained for a set of ordered pairs of the transmissions speed value and the drive demand power value. That is, each fuel saved ratio curve may be related to a set of ordered pairs of the transmission speed value and the drive demand power value, and each fuel saved ratio curve may correspond to a constant fuel saved ratio value. The optimized fuel saved ratio discharge map includes one or more fuel saved ratio curves that correspond to operating the engine system 100 with the electric machine 140 using power from the battery 160 to rotate the transmission 150. The optimized fuel saved ratio charge map includes one or more fuel saved ratio curves that correspond to operating the engine system 100 with the electric machine 140 generating power (e.g., from regenerative braking or from the engine 130) and providing the generated power to the battery 160 or another electrical device of the engine system 100.

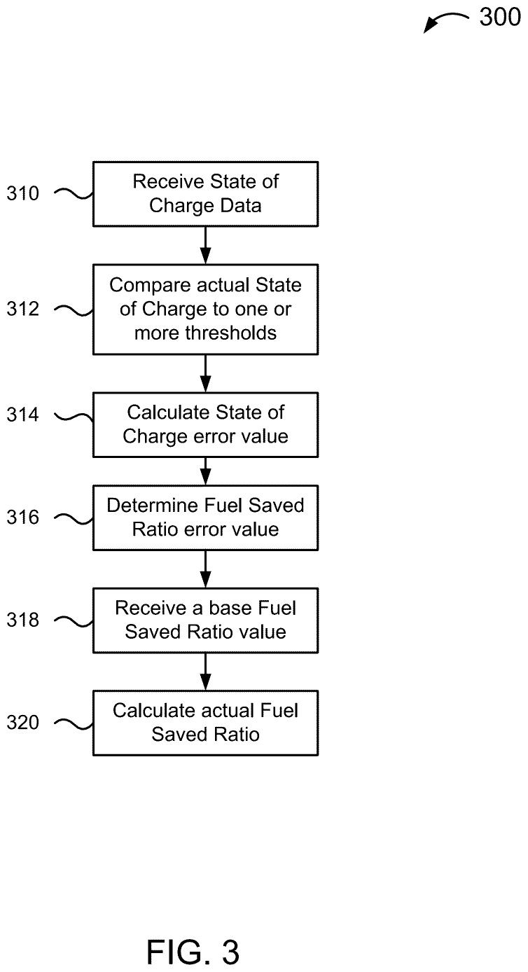

FIG. 3 is a flow diagram of a method 300 of receiving, determining, and/or calculating a fuel saved ratio value for the engine system 100, according to an example embodiment. In particular, the controller 120 is structured to execute a comparison and determination or calculation procedure to perform the method 300. In some embodiments one or more of the processes of the method 300 are optional. In other embodiments, one or more of the processes of the method 300 may be combined with one or more other depicted process. In still other embodiments additional processes may be added to the method 300 without departing from the spirit and scope of the present disclosure.

At process 310, the controller 120 receives state of charge data regarding the battery 160. The received state of charge data indicates a current state of charge value of the battery 160. The state of charge value is or is based on an amount of electrical energy stored by the battery 160. For example, the state of charge value may be the amount of electrical energy stored by the battery 160 (typically measured in kilowatt-hours). In another example, the state of charge value may be the amount of electrical energy stored by the battery 160 divided by the total capacity of the battery (typically expressed as a percentage). In some embodiments, when the system 100 includes more than one battery 160, each battery 160 has a corresponding state of charge value that is or is based on an amount of electrical energy stored by the corresponding battery. In other embodiments, when the system 100 includes more than one battery 160, the amount of energy stored by all the batteries in the system 100 is represented by a singled state of charge value. In either case, the state of charge value(s) may be expressed as the amount of energy stored by the batteries, or the amount of energy stored by the batteries divided by the capacity of the batteries.

At process 312, the controller 120 compares the received state of charge value to one or more thresholds. In some embodiments, the one or more thresholds include a first threshold (e.g., a minimum threshold, a lower threshold, etc.) and a second threshold (e.g., a maximum threshold, an upper threshold, etc.). In some embodiments, the first threshold is an upper threshold, and the second threshold is a lower threshold, and a range of state of charge values is defined between the upper threshold and the lower threshold, inclusive.

At process 314, the controller 120 receives and/or determines or calculates a state of charge error value. In some embodiments, the state of charge error value refers to a difference between the actual state of charge value and the one or more thresholds. For example, the controller 120 may determine a difference between the actual state of charge value and the first threshold and/or a difference between the actual state of charge value and the second threshold. More specifically, the controller 120 may determine a difference between the actual state of charge value and the first threshold responsive to the actual state of charge value being below the first threshold. The controller 120 may determine a difference between the actual state of charge value and the second threshold responsive to the actual state of charge value being above the second threshold. In some embodiments, the state of charge error value is based on comparing the actual state of charge value to the one or more thresholds. For example, the controller 120 may determine that the state of charge error value is zero responsive to the actual state of charge value being at or above the first threshold and at or below the second threshold (e.g., within the range of state of charge values between the first threshold and the second threshold). In other embodiments, the controller 120 may receive the state of charge error value (e.g., from the memory device 206, or via the communications interface 208 and from a remote computing system, a sensor (e.g., a real sensor or a virtual sensor), and/or another computing system onboard or remote from the engine system 100).

At process 316, the controller 120 determines a fuel saved ratio error value. The fuel saved ratio error value is determined or calculated using the state of charge error value as an input for a mathematical model, such as a proportional integral (PI) model. Thus, at process 316, the controller 120 executes the PI model to determine the fuel saved ratio error value.

At process 318, the controller 120 receives a base fuel saved ratio value. The base fuel saved ratio value is a predetermined value that, for example, can be selected by a user. Accordingly, the controller 120 may receive the base fuel saved ratio value via a user input. At process 320, the controller 120 calculates the actual fuel saved ratio of the engine system 100. The fuel saved ratio (FSR) is the summation of the base fuel saved ratio value and the fuel saved ratio error value.

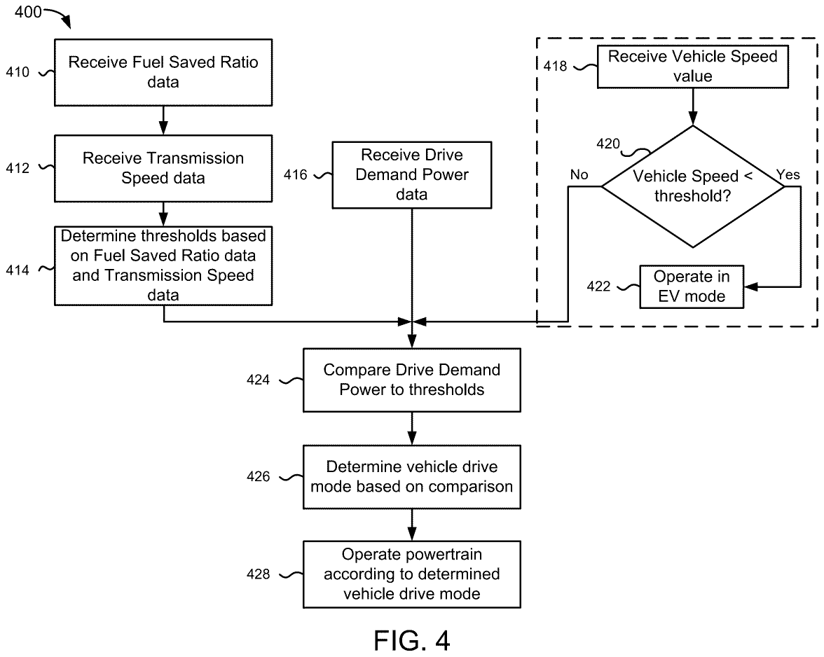

Based on the foregoing, an example of operation may be described as follows. The controller 120 receives state of charge data regarding the battery 160. The controller 120 compares the received state of charge data to one or more state of charge thresholds. Based on the comparison of the received state of charge data to the one or more state of charge thresholds, the controller 120 receives and/or determines or calculates a state of charge error value representing a difference between the state of charge value and the one or more state of charge thresholds. Using the state of charge error value as an input for the mathematical model as described above in reference to the process 316, the controller 120 determines a fuel saved ratio error value. The controller 120 then receives a base fuel saved ratio value. Responsive to receiving the fuel saved ratio error value and the base fuel saved ratio value, the controller 120 determines a fuel saved ratio (FSR) of the engine system 100. Advantageously, determining the FSR of the engine system 100 facilitates the determination of the vehicle drive mode. That is, the FSR determined in this operation is used as an input to determining and implementing the vehicle drive mode. In determining the vehicle drive mode, the controller 120 uses received data values to generate thresholds indicating optimal drive modes for the vehicle at least partially based on the FSR. The determined vehicle drive mode based on the FSR will allow the engine system 100 to satisfy the drive demand power. Implementation of the determined vehicle drive mode will cause the engine system 100 to satisfy the drive demand power. While operating in the determined vehicle drive mode, the engine system 100 may achieve a target fuel saved ratio. More specific details regarding selecting the vehicle drive mode are described herein with respect to FIG. 4.

FIG. 4 is a flow diagram of a method 400 of determining and implementing the vehicle drive mode, according to an exemplary embodiment. In particular, the controller 120 is structured to perform the method 400. In some embodiments one or more of the processes of the method 400 are optional. For example, processes 418, 420, and 422 are optional and may be omitted. In other embodiments, one or more of the processes of the method 400 may be combined with one or more other depicted process. In still other embodiments additional processes may be added to the method 400 without departing from the spirit and scope of the present disclosure.

At process 410, the controller 120 receives fuel saved ratio data. In some embodiments, the fuel saved ratio data is or includes one or more fuel saved ratio values, which can be represented as one or more fuel saved ratio curves (e.g., one or more fuel saved ratio curves retrieved from one or more maps). In these embodiments, the fuel saved ratio data may be determined and/or received by the controller 120 and stored at the memory device 206. In some embodiments, the fuel saved ratio data may be determined by using Equation 1 and/or by the method 300. For example, the controller 120 may determine the fuel saved ratio data using Equation 1 and/or using the method 300. Additionally and/or alternatively, the controller 120 may receive the fuel saved ratio data from a remote computing system and/or another computing system onboard or remote from the engine system 100). In other embodiments, the fuel saved ratio data is or includes a target fuel saved ratio value, which may be a predetermined value. For example, the target fuel saved ratio value may be received via a user input. The target fuel saved ratio value may be used to identify one or more fuel saved ratio curves from the one or more maps.

At process 412, the controller 120 receives transmission speed data. The transmission speed data may include a transmission speed value (e.g., a speed of rotation value/a rotational speed value) of the transmission 150. In some embodiments, the controller 120 receives the transmission speed value from one or more sensors 190. For example, the transmission speed value may be measured by one or more sensors 190 or determined by one or more sensors 190 (e.g., in the case of virtual sensors).

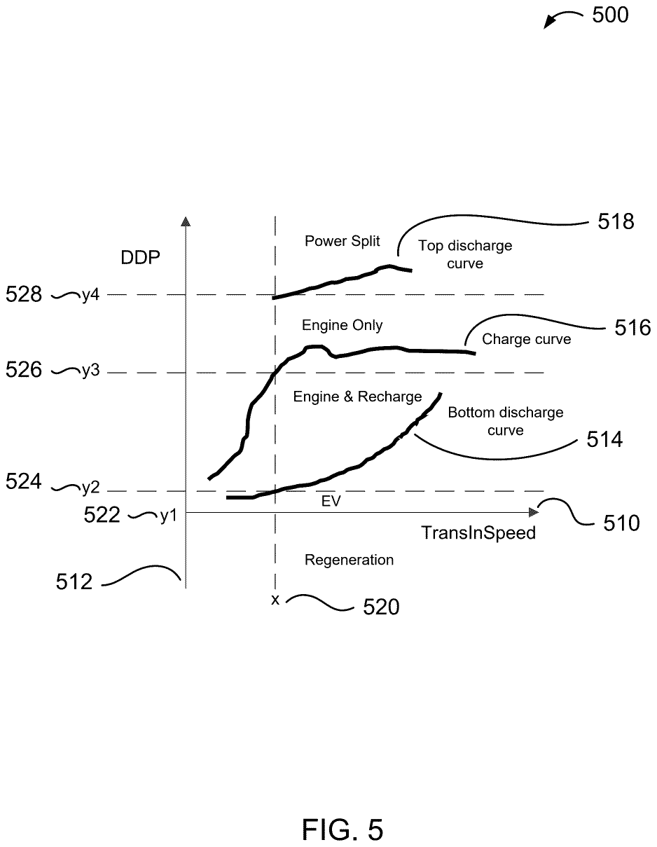

At process 414, the controller 120 uses the received fuel saved ratio data and transmission speed data to determine one or more power thresholds. The one or more power thresholds may be used in determining the vehicle drive mode. In some embodiments, the controller 120 uses the fuel saved ratio data is used to select a plurality of fuel saved ratio curves from the optimized fuel saved ratio discharge map and/or the optimized fuel saved ratio charge map. In other embodiments, the controller 120 receives the plurality of fuel saved ratio curves from the optimized fuel saved ratio discharge map and/or the optimized fuel saved ratio charge map as part of the received fuel saved ratio data. The controller 120 uses the transmission speed data to identify a first input value for each fuel saved ratio curve (e.g., a lateral position along the selected curves, when viewed on a graph). The controller 120 determines one or more power thresholds by identifying the second input value that corresponds to the first input value (e.g., the transmission speed value) and the identified fuel saved ratio curve. For example, the controller 120 determines one or more power thresholds by identifying the intersection between transmission speed value (which is represented by a vertical line on a graph) and each of the fuel saved ratio curves. An example graph depicting the fuel saved ratio curves is shown and described herein with respect to FIG. 5.

At process 416, the controller 120 receives the drive demand power data. The drive demand power data is received by the controller 120 as a user input (e.g., via an accelerator pedal, a brake pedal, a voice command, a combination thereof, etc.). As described herein, the drive demand power data or values refer to an indication of the power demanded from the system by an operator of the system. In other embodiments, the drive demand power data is received from an autonomous driving system (ADS) or advanced driver assistance system (ADAS).

According to an example embodiment, the drive demand power may be positive or negative based on the user input. For example, when the brake input device 112 is depressed, the drive demand power value may be negative. This indicates that the demanded power is negative to reduce the vehicle speed and momentum. While the accelerator input device 110 is depressed, the drive demand power may be a positive value. This indicates that additional power is desired to achieve a desired vehicle speed and/or power. The drive demand power may be zero when neither the accelerator input device 110 nor the brake input device 112 is depressed.

Referring generally to processes 418, 420, and 422, the controller 120 may execute an additional and/or alternative determination process regarding determination of the vehicle drive mode. At process 418, the controller 120 receives a vehicle speed value, this vehicle speed value can be collected, received, and/or obtained by a sensor 190, such as a vehicle speed sensor, which may be at least one of a monopolar inductive sensor, bipolar inductive sensor, magneto-resistive sensor, hall effect sensor, or any other sensor which is configured to collect vehicle speed data and communicate with the controller 120. At process 420, the controller 120 compares the received vehicle speed data to a predetermined threshold stored by the controller 120. Responsive to the vehicle speed being below the predetermined threshold, the controller 120 causes the engine system 100 to operate in an electric vehicle mode, whereby the electric machine 140 provides the drive power. Upon determining that the vehicle speed is at or above the predetermined threshold, the controller 120 will continue with the remaining processes of method 400. As shown by the dotted lines in FIG. 4, in some embodiments, processes 418-422 are optional.

At process 424, the controller 120 compares the received drive demand power value to one or more of the thresholds determined in process 414. At process 426, the controller 120 determines the vehicle drive mode for the engine system 100 based on the comparison. The vehicle drive mode for the engine system 100 is one of a regeneration mode whereby the electric machine generates power, an electric vehicle mode whereby the electric machine provides the drive power, an engine and recharge mode whereby the engine provides the drive power and additional power such that the electric machine generates energy to charge the battery using the additional power, an engine only mode whereby the engine provides the drive power, or a power split mode whereby the engine and the electric machine cooperate to provide the drive power. For example, the vehicle drive mode is the regeneration mode if the drive demand power is below a first threshold, where the first threshold is zero (i.e., the drive demand power is negative). The vehicle drive mode is the electric vehicle mode if the drive demand power is above the first threshold and at or below a second threshold. The vehicle drive mode is the engine and recharge mode if the drive demand power is above the second threshold and at or below a third threshold. The vehicle drive mode is the engine only mode if the drive demand power is above the third threshold and at or below a fourth threshold. The vehicle drive mode is the power split mode if the drive demand power is above the fourth threshold. At process 428, the controller 120 operates the powertrain according to the determined vehicle drive mode. The powertrain then operates as set forth by the determined vehicle drive mode.

Based on the foregoing, an example of operation may be described as follows. The controller 120 receives fuel saved ratio data. The controller 120 receives transmission speed data responsive to receiving the fuel saved ratio data. Based on the received fuel saved ratio data and the transmission speed data, the controller 120 determines one or more power thresholds. The controller 120 receives drive demand power data. Responsive to determining the one or more power thresholds and receiving the drive demand power data, the controller 120 compares the drive demand power data to the one or more power thresholds. Based on the comparison between the dive demand power data and the one or more power thresholds, the controller 120 determines a vehicle drive mode. For example, the vehicle drive mode is the regeneration mode when the drive demand power is below the first threshold. The vehicle drive mode is the electric vehicle mode when the drive demand power is above the first threshold and at or below a second threshold. The vehicle drive mode is the engine and recharge mode when the drive demand power is above the second threshold and at or below a third threshold. The vehicle drive mode is the engine only mode when the drive demand power is above the third threshold and at or below a fourth threshold. The vehicle drive mode is the power split mode when the drive demand power is above the fourth threshold. Responsive to determining the vehicle drive mode, the controller 120 operates the powertrain according to the determined vehicle drive mode. Advantageously, operating the powertrain according to the determined vehicle drive mode may improve (e.g., increase) the FSR value of the powertrain. In a first example embodiment, operating in the power split mode may reduce the amount of fuel consumed by the powertrain by using electrical energy to achieve at least a portion the drive demand power. In a second example embodiment, operating in the electric vehicle mode may reduce the amount of fuel consumed by the powertrain by using electrical energy as the primary source of power for the powertrain. In a third example embodiment, operating the powertrain in the engine only mode may reduce the amount of fuel consumed by the powertrain by preventing the electric machine 140 from charging the battery 160. Here, the benefit gained by charging the battery 160 (e.g., the increased stored electrical energy) would not offset the increased fuel consumption (e.g., the FSR value would be lower if the electric machine 140 was used to charge the battery 160). In a fourth example embodiment, operating the powertrain in the engine and recharge mode may reduce a future amount of fuel consumed by the powertrain by charging the battery 160. Here, when operating the powertrain in the engine and recharge mode, the benefit gained by charging the battery 160 (e.g., the increased stored electrical energy) would offset the increased fuel consumption, resulting in a greater FSR value. In a fourth example embodiment, operating the powertrain in the regeneration mode may reduce a future amount of fuel consumed by the powertrain by charging the battery 160.

Additionally, the controller 120 may optionally operate the powertrain in an electric vehicle mode, responsive to a vehicle speed value being below a predetermined threshold. That is, the controller 120 receives the vehicle speed value, compares it to the predetermined threshold, and operates the powertrain in the electric vehicle mode responsive to the vehicle speed value being below the predetermined threshold. Advantageously, operating the powertrain in the electric vehicle mode may cause the engine system 100 to achieve a target fuel saved ratio, mitigating fuel consumption of the engine system 100. By way of example operating the powertrain in the electric vehicle mode when the vehicle speed value is below the predetermined threshold consumes less fuel and/or electrical energy than the other driving modes for the same operating conditions (e.g., vehicle speed, transmission speed, and/or drive demand power). Accordingly, operating the powertrain in the electric vehicle mode can result in improving (e.g., increasing or maximizing) the FSR value.

FIG. 5 is an example of an optimized fuel saved ratio map 500, according to an exemplary embodiment. As shown in FIG. 5, the map 500 shows an example of curves selected from stored optimized maps. According to an exemplary embodiment, the curves used in the map 500 include a bottom discharge curve 514, a charge curve 516, and a top discharge curve 518 for the fuel saved ratio of the engine system 100. Further shown in FIG. 5 is a horizontal axis 510 showing transmission speed, and an example transmission speed, shown as x 520. The intersection between the selected curves (e.g., bottom discharge curve 514, charge curve 516, and top discharge curve 518) and the transmission speed x 520 defines the thresholds used for determination of vehicle drive mode. Shown along a vertical axis 512 are four power thresholds. At least one of a first power threshold, y1 522, a second power threshold, y2 524, a third power threshold, y3 526, and/or a fourth power threshold, y4 528 are used to determine the vehicle drive mode. The map 500 includes labels indicating the vehicle drive mode for a given range of drive demand power values. The vehicle drive mode is the regeneration mode, whereby the electric machine 140 generates power when the drive demand power is less than y1 522. The vehicle drive mode is the electric vehicle mode, whereby the electric machine 140 provides the drive power when the drive demand power is greater than y1 522 and less than or equal to y2 524. The vehicle drive mode is the engine and recharge mode, whereby the engine 130 provides the drive power and additional power such that the electric machine 140 generates energy to charge the battery 160 using the additional power when the drive demand power is greater than y2 524 and less than or equal to y3 526. The vehicle drive mode is the engine only mode, whereby the engine 130 provides the drive power when the drive demand power is greater than y3 526 and less than or equal to y4 528. The vehicle drive mode is the power split mode, whereby the engine 130 and the electric machine 140 cooperate to provide the drive power when the drive demand power is greater than y4 528.

For example, while the transmission speed is x 520, the vehicle drive mode is determined by the drive demand power. The vehicle drive mode may be the electric vehicle mode when the drive demand power is greater than y1 522 and less than or equal to y2 524. As drive demand power increases, the vehicle drive mode is the engine and recharge mode when the drive demand power is greater than y2 524 and less than or equal to y3 526. Further, as the drive demand power continues to increase, the vehicle drive mode is the engine only mode when the drive demand power is greater than y3 526 and less than or equal to y4 528. When the drive demand power is greater than y4 528, the vehicle drive mode is the power split mode (e.g., a power is provided by a combination of the engine and electric machine). As the drive demand power decreases, the vehicle drive mode is the power split mode when the drive demand power is greater than y4 528. Further, as the drive demand power continues to decrease, the vehicle drive mode may be the engine only mode when the drive demand power is less than or equal to y4 528 and greater than y3 526. The vehicle drive mode may be the engine and recharge mode when the drive demand power is less than or equal to y3 526 and greater than y2 524. When the drive demand power is less than or equal to y2 524 and greater than y1 522, the vehicle drive mode is the electric vehicle mode. When the drive demand power is less than or equal to y1 522, the vehicle drive mode is the regeneration mode. The controller 120 may implement each of these modes based on detecting these conditions/situations.

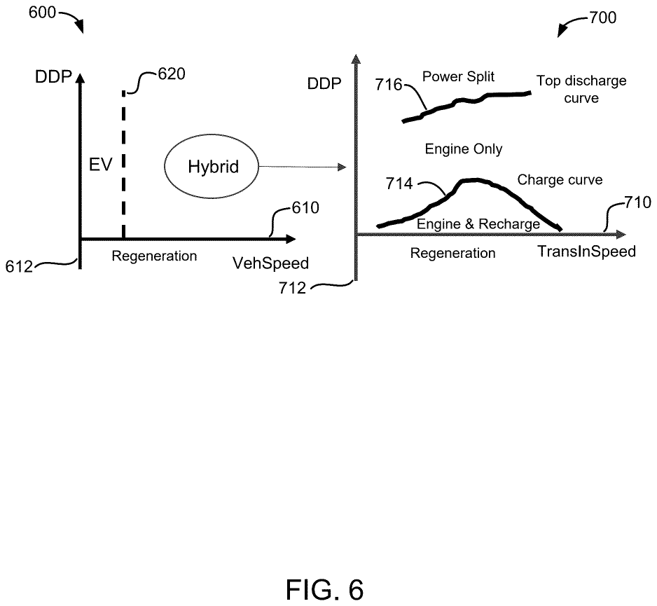

FIG. 6 is an example of a pair of maps or graphs depicting drive demand power and speed that may be used to determine the vehicle drive mode, according to exemplary embodiments. As shown in FIG. 6, a first map 600 shows an example of a map used in the determination of the vehicle drive mode between the regeneration mode, the electric vehicle mode, and the use of a hybrid operation control map 700 that includes the power split and certain engine modes. The first map 600 includes a horizontal axis 610 showing vehicle speed, a vertical axis 612 showing drive demand power, and a vehicle speed threshold 620 used for determination of vehicle drive mode. According to an exemplary embodiment, the first map 600 may be used to carry out an operation similar to the processes 420-422 as described with reference to FIG. 4. For example, the controller 120 may compare a received vehicle speed value to the vehicle speed threshold 620 to determine the vehicle drive mode. Upon determining that the received vehicle speed is at or below the vehicle speed threshold 620, the vehicle drive mode is the electric vehicle mode as determined and implemented by the controller 120. Upon determining that the received vehicle speed is above the vehicle speed threshold 620, the hybrid operation control map 700 is used to determine the vehicle drive mode by the controller 120. As shown in FIG. 6, the hybrid operation control map 700 shows an example of curves selected from stored optimized maps. According to an exemplary embodiment, the curves used in the hybrid operation control map 700 include a charge curve 714 and a top discharge curve 716 for the fuel saved ratio of the engine system 100. Further shown in FIG. 6 is a horizontal axis 710 showing transmission speed, and a vertical axis 712 showing drive demand power. At least one of the charge curve 714 and/or the top discharge curve 716 are used to determine the vehicle drive mode by the controller 120, in some embodiments. The vehicle drive mode is the regeneration mode when the drive demand power is less than zero. The vehicle drive mode is the engine and recharge mode when the drive demand power is greater than zero and less than or equal to a value of the charge curve 714 at a given transmission speed of the transmission 150. The vehicle drive mode is the engine only mode when the drive demand power is greater than the value of the charge curve 714 and less than or equal to a value of the top discharge curve 716 at the given transmission speed of the transmission 150. The vehicle drive mode is the power split mode when the drive demand power is greater than the value of the top discharge curve 716 at the given transmission speed.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein

What is claimed is:

1. A system comprising:
a controller coupled to a powertrain comprising an internal combustion engine and an electric machine, the controller comprising at least one processor and at least one memory device storing instructions that, when executed by the at least one processor, cause the controller to perform operations comprising:
receiving a state of charge value regarding a battery;
determining, based on the state of charge value, a fuel saved ratio value;
receiving a target fuel saved ratio value;
receiving a transmission speed value regarding a transmission coupled to the internal combustion engine;
receiving a drive demand power value;
determining, based on the target fuel saved ratio value and the transmission speed value, one or more power thresholds;
determining a vehicle drive mode based on comparing the drive demand power value to the one or more power thresholds; and
implementing the vehicle drive mode by causing the powertrain to operate according to the vehicle drive mode.

2. The system of claim 1, wherein determining the vehicle drive mode comprises:
comparing the drive demand power value to a first threshold of the one or more power thresholds; and
responsive to the drive demand power value being below the first threshold, determining that the vehicle drive mode is a regeneration mode whereby the electric machine generates power.

3. The system of claim 2, wherein a value of the first threshold is zero, such that the vehicle drive mode is the regeneration mode when the drive demand power value is negative.

4. The system of claim 2, wherein determining the vehicle drive mode comprises:
comparing the drive demand power value to the first threshold and a second threshold of the one or more power thresholds; and
responsive to the drive demand power value being above the first threshold and at or below the second threshold, determining that the vehicle drive mode is an electric vehicle mode whereby the electric machine provides drive power.

5. The system of claim 4, wherein determining the vehicle drive mode further comprises:
comparing the drive demand power value to the second threshold and a third threshold; and
responsive to the drive demand power value being above the second threshold and at or below the third threshold, determining that the vehicle drive mode is an engine and recharge mode whereby the internal combustion engine provides the drive power and the electric machine generates energy to charge the battery using additional power output relative to the drive power from the internal combustion engine.

6. The system of claim 5, wherein determining the vehicle drive mode comprises:
comparing the drive demand power value to the third threshold and a fourth threshold;
responsive to the drive demand power value being above the third threshold and at or below the fourth threshold, determining that the vehicle drive mode is an engine only mode whereby the internal combustion engine provides the drive power; and
responsive to the drive demand power value being above the fourth threshold, determining that the vehicle drive mode is a power split mode, whereby the internal combustion engine and the electric machine cooperate to provide the drive power.

7. The system of claim 2, wherein determining the vehicle drive mode comprises:
comparing the transmission speed value to a predetermined speed threshold; and
responsive to the transmission speed value being at or below the predetermined speed threshold, determining that the vehicle drive mode is an electric vehicle mode whereby the electric machine provides drive power.

8. The system of claim 7, wherein the drive demand power value is compared to the first threshold of the one or more power thresholds responsive to the transmission speed value being above the predetermined speed threshold.

9. The system of claim 7, wherein determining the vehicle drive mode comprises:
responsive to the transmission speed value being above the predetermined speed threshold, comparing the drive demand power value to the first threshold and a second threshold of the one or more power thresholds; and
responsive to the drive demand power value being above the first threshold and at or below the second threshold, determining that the vehicle drive mode is an engine and recharge mode whereby the internal combustion engine provides the drive power and additional power relative to the drive power such that the electric machine generates energy to charge the battery using the additional power.

10. The system of claim 9, wherein determining the vehicle drive mode further comprises:
comparing the drive demand power value to the second threshold and a third threshold greater than the second threshold;
responsive to the drive demand power value being above the second threshold and at or below the third threshold, determining that the vehicle drive mode is an engine only mode whereby the internal combustion engine provides the drive power; and
responsive to the drive demand power value being above the third threshold, determining that the vehicle drive mode is a power split mode, whereby the internal combustion engine and the electric machine cooperate to provide the drive power.

11. A method comprising:
receiving, by a controller, a state of charge value regarding a battery coupled to the controller;
determining, by the controller and based on the state of charge value, a fuel saved ratio value regarding an amount of fuel saved when discharging one unit of energy from the battery or an amount of fuel consumed when one unit of energy is charged to the battery;
receiving, by the controller, a target fuel saved ratio value;
receiving, by the controller, a transmission speed value regarding operation of a transmission coupled to the controller;
receiving, by the controller, a drive demand power value indicative of an amount of power demanded from a vehicle including the transmission;
determining, by the controller, one or more power thresholds based on the target fuel saved ratio value and the transmission speed value;
determining, by the controller, a vehicle drive mode based on comparing the drive demand power value to the one or more power thresholds; and
implementing, by the controller, the vehicle drive mode by causing a powertrain of the vehicle coupled to the controller to operate according to the vehicle drive mode.

12. The method of claim 11, wherein determining the vehicle drive mode comprises:
comparing the drive demand power value to one or more of a first threshold, a second threshold, a third threshold, or a fourth threshold of the one or more power thresholds;
responsive to the drive demand power value being below the first threshold, determining that the vehicle drive mode is a regeneration mode whereby an electric machine generates power;
responsive to the drive demand power value being above the first threshold and at or below the second threshold, determining that the vehicle drive mode is an electric vehicle mode whereby the electric machine provides drive power;
responsive to the drive demand power value being above the third threshold and at or below the fourth threshold, determining that the vehicle drive mode is an engine only mode whereby an engine provides the drive power; and
responsive to the drive demand power value being above the fourth threshold, determining that the vehicle drive mode is a power split mode, whereby the engine and the electric machine cooperate to provide the drive power.

13. The method of claim 12, wherein a value of the first threshold is zero, such that the vehicle drive mode is the regeneration mode when the drive demand power value is negative.

14. The method of claim 11, wherein determining the vehicle drive mode comprises:
comparing the transmission speed value to a predetermined speed threshold; and
responsive to the transmission speed value being at or below the predetermined speed threshold, determining that the vehicle drive mode is an electric vehicle mode whereby an electric machine provides drive power.

15. The method of claim 14, wherein the drive demand power value is compared to a first threshold of the one or more power thresholds responsive to the transmission speed value being above the predetermined speed threshold.

16. The method of claim 15, wherein determining the vehicle drive mode comprises:
responsive to the transmission speed value being above the predetermined speed threshold, comparing the drive demand power value to the first threshold and a second threshold of the one or more power thresholds; and
responsive to the drive demand power value being above the first threshold and at or below the second threshold, determining that the vehicle drive mode is an engine and recharge mode whereby an engine provides the drive power and additional power relative to the drive power such that the electric machine generates energy to charge the battery using the additional power.

17. The method of claim 16, wherein determining the vehicle drive mode further comprises:
comparing the drive demand power value to the second threshold and a third threshold;
responsive to the drive demand power value being above the second threshold and at or below the third threshold, determining that the vehicle drive mode is an engine only mode whereby the engine provides the drive power; and
responsive to the drive demand power value being above the third threshold, determining that the vehicle drive mode is a power split mode, whereby the engine and the electric machine cooperate to provide the drive power.

18. A non-transitory computer-readable media storing instructions that, when executed by one or more processors of at least one processing circuit, cause the at least one processing circuit to perform operations comprising:
receiving, by a controller, a state of charge value regarding a battery coupled to the controller;
determining a fuel saved ratio value regarding an amount of fuel saved when discharging one unit of energy from the battery or an amount of fuel consumed when one unit of energy is charged to the battery, based on the state of charge value;
receiving a target fuel saved ratio value;
receiving a transmission speed value regarding operation of a transmission coupled to the controller;
receiving a drive demand power value indicative of an amount of power demanded from a vehicle including a transmission;
determining one or more power thresholds based on the target fuel saved ratio value and the transmission speed value;
determining vehicle drive mode based on comparing the drive demand power value to the one or more power thresholds; and
implementing the vehicle drive mode by causing a powertrain of the vehicle coupled to the controller to operate according to the vehicle drive mode.

19. The non-transitory computer-readable media of claim 18, wherein determining the vehicle drive mode comprises:
comparing the drive demand power value to one or more of a first threshold, a second threshold, a third threshold, or a fourth threshold of the one or more power thresholds;
responsive to the drive demand power value being below the first threshold, determining that the vehicle drive mode is a regeneration mode whereby an electric machine generates power;
responsive to the drive demand power value being above the first threshold and at or below the second threshold, determining that the vehicle drive mode is an electric vehicle mode whereby the electric machine provides drive power;
responsive to the drive demand power value being above the third threshold and at or below the fourth threshold, determining that the vehicle drive mode is an engine only mode whereby an engine provides the drive power; and
responsive to the drive demand power value being above the fourth threshold, determining that the vehicle drive mode is a power split mode, whereby the engine and the electric machine cooperate to provide the drive power.

20. The non-transitory computer-readable media of claim 18, wherein determining the vehicle drive mode comprises:
comparing the transmission speed value to a predetermined speed threshold;
responsive to the transmission speed value being at or below the predetermined speed threshold, determining that the vehicle drive mode is an electric vehicle mode whereby an electric machine provides drive power;
responsive to the transmission speed value being above the predetermined speed threshold, comparing the drive demand power value to one or more of a first threshold, a second threshold, or a third threshold, of the one or more power thresholds;
responsive to the drive demand power value being above the first threshold and at or below the second threshold, determining that the vehicle drive mode is an engine and recharge mode whereby an engine provides the drive power and additional power such that the electric machine generates energy to charge the battery using the additional power;
responsive to the drive demand power value being above the second threshold and at or below the third threshold, determining that the vehicle drive mode is an engine only mode whereby the engine provides the drive power; and
responsive to the drive demand power value being above the third threshold, determining that the vehicle drive mode is a power split mode, whereby the engine and the electric machine cooperate to provide the drive power.
